(19) United States
(12) Patent Application Publication
(10) Pub. No.: US 2006/0010197 A1
(43) Pub. Date: Jan. 12, 2006

(54) Multimedia collaboration and communications

(76) Inventor: Francis Ovenden, Groton, MA (US)

Correspondence Address: STEUBING AND MCGUINESS & MANARAS LLP, 125 NAGOG PARK, ACTON, MA, 01720, US

(21) Appl. No.: 10/884,896

(22) Filed: Jul. 6, 2004

(51) Int. Cl. G06F 15/16

(52) U.S. Cl. 709/204

(57) ABSTRACT

A computer interface for facilitating collaboration using tools from different vendors includes an information base and a communications manager. Files created or shared in association with a collaboration may be automatically associated with a particular collaboration to facilitate access by all members. The information base may include a list of files associated with the collaboration, a folder with icons representing files and messages previously shared, and a calendar for scheduling events associated with the collaboration. The communications manager includes a list of applications available for use in conjunction with the collaboration, including communications tools, and a list of members of the collaboration. The interface is generated by a collaboration object which includes the files associated with the collaboration and code for interacting with the various, different applications employed by the members of the collaboration.

### FIELD OF THE INVENTION

The present invention relates generally to multimedia collaboration tools, and more specifically to unified control of multimedia collaboration tools.

### BACKGROUND OF THE INVENTION

As access to broadband networks has become more widespread, multimedia collaboration tools have become popular. Examples of such multimedia collaboration tools include electronic whiteboards, instant text messaging, email, application sharing, voice conferencing, and video conferencing. Each tool typically provides useful functionality associated with one particular aspect of collaboration. For example, instant messaging enables relatively fast sharing of short text messages and some files. In the course of a collaborative effort it may be desirable to use various different collaboration tools, and perhaps to use some of those tools simultaneously. However, this can be inconvenient because the multimedia tools employed by a user are often developed and provided by different vendors and require the user to adapt his or her work flow around use of the individual tools in order to carry out job functions. Further, while one software vendor may provide some inter-working of its various tools, it is generally undesirable to be constrained to a single vendor.

### SUMMARY OF THE INVENTION

In accordance with the present invention a unified user interface is provided for enhancing use of multiple, distinct multimedia collaboration tools. The interface facilitates organization of files, data and tools associated with a particular collaboration in order to enhance efficiency and ease of use. Further, the interface helps a user focus on the tasks at hand rather than the collaboration tools.

In one embodiment of the invention, the interface is presented in a manner similar to files and folders in an operating system, which can be opened by clicking on an icon associated with the collaboration. The interface includes an information base portion for organizing and storing information related to a task, and a communications manager portion for using and controlling different communications tools for communications related to the task. The information base may display a list of files associated with the collaboration, a list of applications available for use in conjunction with the collaboration, a list of members of the collaboration, and a calendar for scheduling events associated with the collaboration. Collaboration is managed by a coordinating member who may be the meeting coordinator, project prime, or a delegated member of the collaborative team. Collaborative activities are scheduled and information sharing takes place during active collaborative sessions. When setting up a collaborative activity the coordinator may choose to store some or all of the associated team resources on a network-shared storage device to enable some or all of the team members to contribute files or access information outside of active collaborative sessions. The user interface may provide assistance to help setup the network file sharing area. A member of the collaboration team will normally share files with the other team members in real-time, through the interface. For example, the coordinator may access a file individually by mouse-clicking on an icon associated with the file, whereupon the interface launches the associated application and loads the selected file. File sharing may be accomplished by selecting and dragging the file icon to a team icon or to icons associated with each team member, whereupon the interface displays the file on the personal computer of each selected team member. This may be done by running an application to display the file in a window on the coordinators computer and sharing the window display with the selected team members, or by some other method of application file or program sharing supported by third party software on the member's computers. Application sharing may be selected to synchronize the viewing or playback of a file such that each team member is presented with the same file content, e.g., page, slide or audio section, presented on a master personal computer. The master personal computer may be selected as any one of the team member personal computers and may be changed by the coordinator in real-time in order to share control of the file presentation.

The interface may also include a communications object. The communications object includes data in the form of files associated with a particular collaborative effort. For example, the files may include documents and illustrations. The communications object also includes executable code operative to enable use of the files in conjunction with the associated applications. In particular, the executable code prompts launching the appropriate application when the file is accessed by a user or selected for sharing with other team members. The code may include routines for reformatting files for use on different devices or applications. The object may be maintained on a server or in a distributed manner on user devices.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 illustrates a unified user interface for facilitating collaboration.

FIG. 2 illustrates use of the interface of FIG. 1 to prompt a conference call.

FIG. 3 illustrates use of the interface of FIG. 1 to share a document or application.

FIG. 4 illustrates use of the interface of FIG. 1 to capture meeting history.

FIG. 5 illustrates creation of the interface of FIG. 1.

FIG. 6 illustrates a communications object for use with the interface of FIGS. 1-4.

FIG. 7 illustrates operation of the object in a session over a computer network.

### DETAILED DESCRIPTION OF EXEMPLARY EMBODIMENTS

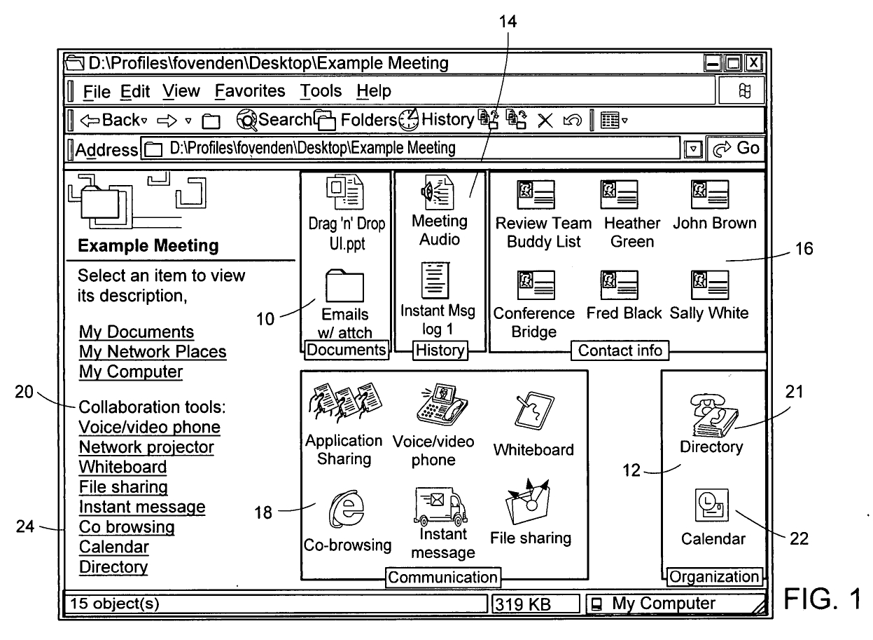

FIG. 1 illustrates a unified user interface for enhancing use of multiple, distinct multimedia collaboration tools. The interface may be employed with a variety of electronic devices (collectively referred to herein as “computers”) including but not limited to personal computers, mobile telephones, and personal digital assistants. The interface includes an information base having a documents section 10, an organization section 12, and a history section 14, and a communications manager with a contacts section 16, a communication section 18, and a list of collaboration tools 20.

The documents section 10 includes icons representing files associated with the collaboration. The actual files may be stored wherever access is possible, and need not be stored as part of the interface. For example, the files could be on a personal computer or on a server available via a network. The listed documents may include not only those documents intended for a specific meeting, but also the documents historically associated with the collaboration, whether or not presented to the group. The user may add a file (or if preferred a link to a file) to the documents section by dragging the file icon from its folder on the user's personal computer, network server, or other device and dropping the file into the documents section of the interface. Other options may be provided such as “save as” and “send to” in the applications used to create and use the files in order to add files to the documents section. Alternatively, files and links to files created or shared in association with the collaboration may be automatically associated and saved in the documents section. Files may be removed from the documents section by selecting the file icon and pressing the delete key on a keyboard, dragging it to the trash can, or selecting a remove option from a pull-down menu on the interface. Permissions for adding, modifying and removing files may also be implemented as is known in the art.

The history section 14 includes icons representing files generated in association with the collaboration. In particular, the files contain a record of interactions between users such as audio and video recordings of meetings and logs of email and instant messages. The history files may be automatically generated in association with use of the communications tools. For example, launch of the instant message tool via the interface may trigger initiation of an instant message log. Subsequent instant messages sent via the interface would then be appended to the previously created instant message log or stored in a newly created instant message log file in accordance with user-selectable preferences.

The contacts section 16 includes icons representing files with contact details for each member of the collaboration. For example, the contacts section may include the name, title, responsibility in the group, address, email address, telephone number, fax number, and other details for each member. Contacts are added to the contacts section by selecting from the directory 21 in the organization section 12. Subgroups of members in the contacts section may be defined by selecting their icons, for example with the mouse by dragging an area and/or adding individuals to the selection by holding down the shift key or some equivalent method supported by the operating system, and selecting an option to create a subgroup icon from a pull-down menu on the interface. Where the directory 21 implements categorization information it may be possible to select contacts based on queries against directory fields. For example, the user may select all members at a worksite by mouse-clicking a “search on directory field” entry from a pull-down menu and creating a search for all entries whose address field matches a given value from a pop-up dialog box.

The communication section 18 includes icons representing the communications applications available to the users. The collection of applications may be limited to only those applications available to all users in order to avoid excluding a user from a portion of the collaboration. The applications may be initiated in a conventional manner by mouse-clicking on the selected icon.

The organization section 12 includes icons representing data files and applications associated with organizing and planning events associated with the collaboration. For example, a directory 21 and calendar 22 are shown in the illustrated example. The directory generally contains company wide contact details not just members of the collaboration. The directory is conveniently located in the collaboration interface to simplify the task of loading the contact info section 16 with the team members contact icons. The calendar provides a tool for scheduling meetings and other collaborative sessions. The calendar may indicate the schedule of each of the users by probing the calendars of individual users.

The list of collaboration tools 20 may include icons representing secondary tools and a secondary means for initiating applications represented by icons elsewhere on the interface. Whether data files and applications are represented to the user as icons, links, lists, or pull-downs is not critical to the invention. In the illustrated example, generally useful secondary tools such as co-browsing and file sharing are listed. These secondary tools may be useful in a wide range of collaborations and hence be made available as a default or user preference. In contrast, the primary set of applications and files may be added by the users during the collaboration or when configuring the interface for a particular collaboration, or as a default set defined as a user preference in the collaboration interface application to be used when a collaboration folder instance is created.

Some of the secondary applications may be like the primary applications which are not part of the interface but are linked via the interface, and others may be part of the interface. In the illustrated embodiment the co-browsing application 24 may be provided by sharing a commercial web browser application. The co-browsing application allows users to coordinate internet browsing during a collaboration session. One user would have control of the browser and move between links and control screen scrolling, data entry and other user input. The users not in control of the browser would automatically be presented with the same screen views as the users in control of the browser, including user input. Similarly, the white board application is a commercial application that provides a screen on which the users can create and share illustrations and text. Like the browser application, control of the whiteboard application can be shared between one or more users and changed as desired. This feature may be useful, for example, to aid in the explanation of ideas presented with other applications such as Microsoft PowerPoint.

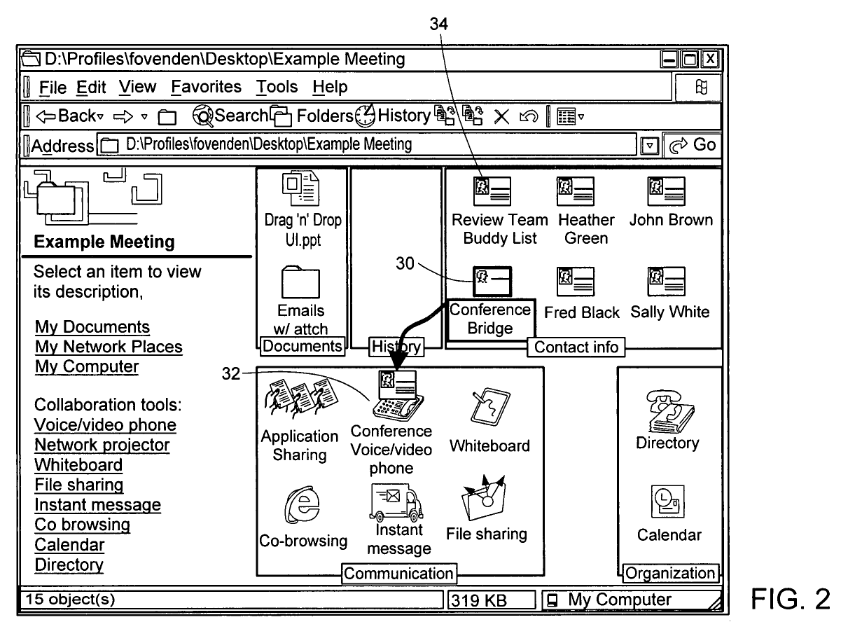

FIG. 2 illustrates use of the interface of FIG. 1 to open a bridge for a conference call with the entire group. In order to establish the conference call the coordinator drags the conference bridge contact file icon 30 over the phone icon 32 to launch the telephony application. The telephony application may be implemented as voice over internet protocol or similar data technology or with traditional telephony equipment interfaced using a computer telephony integration application. The conferencing application opens an audio bridge into which the members of the group must dial in order to join the conference call. The members of the group may be prompted to join the audio bridge by an alert message. The alert message may indicate the sender, the purpose of the conference call and the collaboration with which the alert is associated, e.g., Request: conference call, From: Sally White, Re: ASIC development, For: Project X. The alert message may be sent to the personal computer and PDA of each member via email or instant message, or may appear as a pop-up message or flashing icon on the screen of the user. The alert message may also take the form of a text or audio message sent to the desktop phone, mobile phone and PDA of the member. A similar interface operating on the device or devices of the alerted member may include a join icon or button which allows single action joining to the audio bridge by dialing the bridge in response to the actions of the alerted member. Alternatively the review team buddy list icon 30 may be dragged over the phone icon 32 to launch a conferencing application. In response to the actions of the user, the conferencing application obtains the telephone number of each member of the group from the group contact file and initiates a phone call to each member.

A call to an individual member of the collaboration, or a subset of the members of the collaboration, is made in a similar manner. For example, to call an individual member of the collaboration the user drags the icon associated with that member over the voice/video phone icon. The call is then automatically initiated by the interface. In order to initiate a call with a subset of the members the user selects the icons associated with each of those members and drags those icons over the voice/video phone icon. Alternatively, a separate contact icon may be generated to represent a subset of members of the group. This may be convenient if a particular subset of the group will be frequently interacting with other members of the group. There may be restrictions imposed by a communications application on the number of participants that can be engaged in conference calls particularly for ad-hoc calls where no conference ports are reserved in advance.

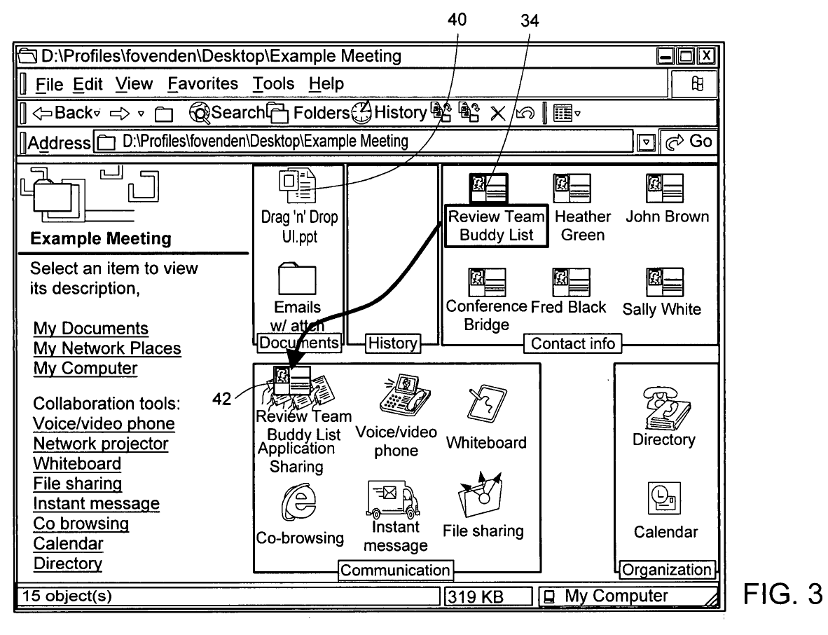

FIG. 3 illustrates use of the interface to share a document file 40. In order to share the file with other members of the collaboration, the user drags the group contact file 34 over the application sharing icon 42. In response, the interface prompts the launch of the associated application on the user's computer or relevant device, or on a server accessible to the users. The application window is then duplicated on the users' devices. The files may be stored locally with one user, locally with some or all users, or on a server. In the case of the illustrated application sharing application, it prompts the user for the file to be displayed. One method of prompting the user is for the application sharing icon 42 to change to indicate the display file should now be dragged and dropped. Another method of prompting the user is for the application to present the user with a menu of files from the documents area.

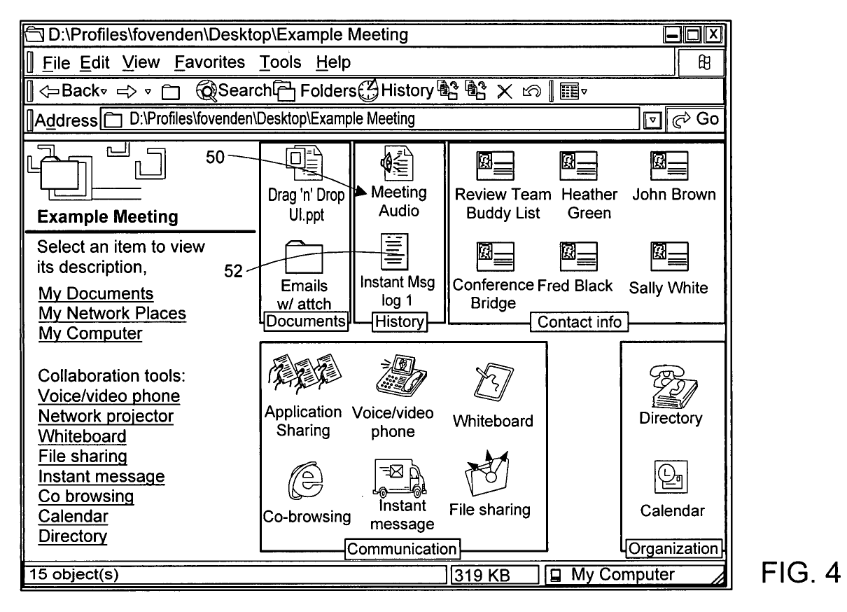

FIG. 4 illustrates use of the interface to capture and review meeting history. During the meeting any log files generated by the communication applications are automatically stored in a meeting history file. In the illustrated embodiment, files of different types such as audio 50 from a conference call and text 52 from instant messaging are stored in different history files. These captured history files can be organized into folders. Other file types may also be generated and stored in the history section, including but not limited to whiteboard graphics, files sent and received, co-browsing URL history, and a list of documents presented. It would also be possible to maintain an integrated history file, which might be chronologically arranged, with links or embedded objects for presenting different types of historical data. History files may be opened or played by double clicking on the relevant icon.

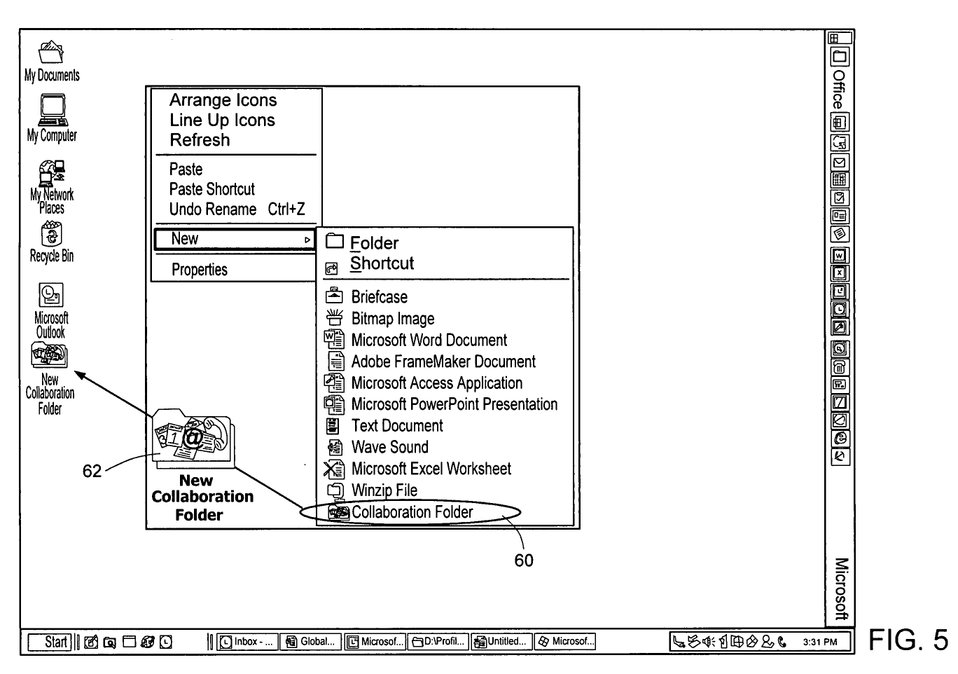

FIG. 5 illustrates creation of an interface for a collaboration. A collaboration folder option 60 is provided in an operating system pull-down menu. Selecting the option provides the user with a default version of the interface as a new collaboration folder 62. The user can rename the folder to be meaningful for a particular collaboration and move it to another location in the local file system or to a remote server just like an ordinary folder or directory. Referring to FIGS. 4 and 5, the user may then add presentation materials to this instantiation of the interface by dragging file icons from the users' computer or another source into the documents section of the interface. Similarly, contacts may be added to the interface by dragging and dropping existing contacts icons from the user directory or other sources, such as Microsoft Outlook if a unified directory has not been implemented. Applications may be added to the interface by dragging and dropping application icons into the communications section of the interface. In one embodiment the interface determines whether each of the added applications in the communications section is available to each of the users in the contact info section, and alerts the user if it is determined that any of the applications is not available to a user.

Once added to the interface, documents may only become available to each of the members of the collaboration if the coordinator provides shared network access. In this case, the documents may be viewed and otherwise used by the users either privately or in the course of a collaboration session. This feature advantageously provides users with an opportunity to review materials prior to their presentation in a collaboration session. The feature also facilitates the distribution of all files desired for a collaboration session, although files may also be shared in real-time in the course of a collaboration session.

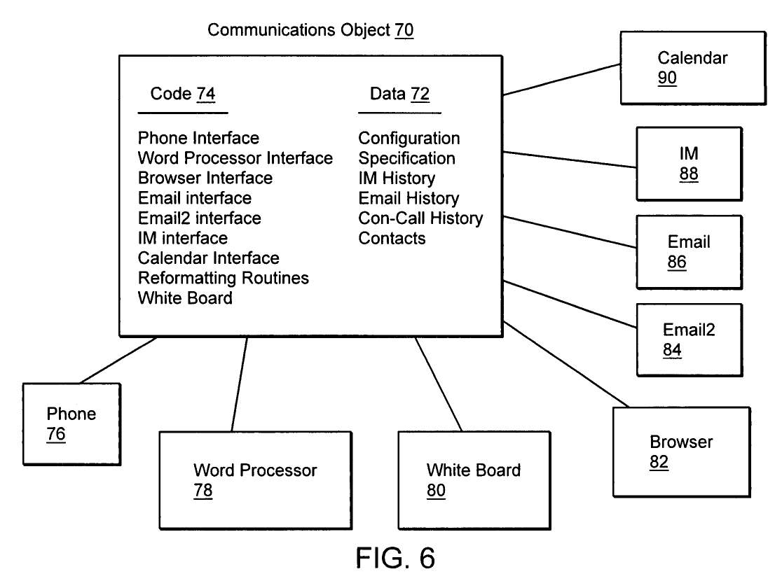

FIG. 6 illustrates a communications object 70 for use with the interface of FIGS. 1-4. The object includes both data 72 and executable code 74. The data includes one or more files containing the configuration details of the particular interface, i.e., indicating how the default interface has been augmented by the user. The data also includes the files associated with the collaboration, including document files, history files and contact info files. The code includes routines for interacting with the applications and other tools available to the collaboration members such as a phone 76, word processing program 78, white board 80, browser 82, email programs 84, 86, instant messaging 88 and electronic calendar 90. Each distinct application may have a particular interface which is used to interact between the object and the applications, and hence between members of the application. The code may also include routines for reformatting data for presentation to users with different devices, or those using different operating systems or different applications for the same function. For example, it would be advantageous for a member using an editor running under Linux to be able to share text files with another member using MSWord running under Windows. The code may also include routines for querying devices of members of the collaboration to establish capabilities and also for scheduling purposes. The code may also include routines for running applications which are a native part of the interface. Alternatively, the code may maintain links to those native applications.

It will occur to those skilled in the art that it may be desirable to maintain the communications object and associated files on a server. The advantage of using a server is that it is potentially always available to all of the users.

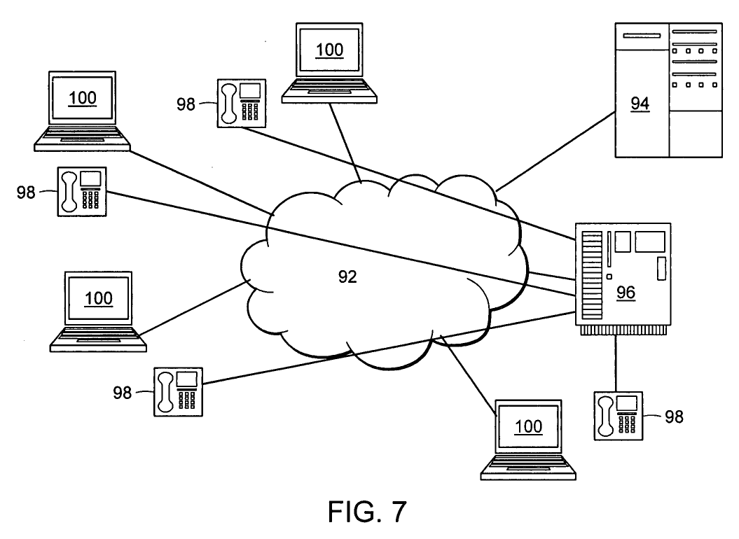

FIG. 7 illustrates operation of the object in a session over a computer network 92. In the illustrated embodiment the communications object is maintained on a server 94. When prompted by a user via the interface to begin a conference call, the object is called to open an audio bridge. In response, the object calls upon a telecommunications device, such as a PBX 96, to set up the audio bridge between phones 98 in a manner known in the telecommunications art. For example, the object may dial the bridge number and enter a passcode to open the bridge. Once the audio bridge is established, the object may forward reminder messages to the selected members via instant message, email or other means to a personal computer or other device 100. When other members have joined the audio bridge, a member may prompt sharing of a file via the interface in the manner already described. In response, the object starts the associated application and loads the selected file. The file is then shared with the members via the network.

It will be appreciated that in the illustrated embodiment the applications are operated as networked applications. Networked applications have advantages and disadvantages. For example, networked applications may be desirable with “thin” client devices which have relatively little processing capability for running applications. However, networked applications are reliant upon network bandwidth, quality of service and reliability for acceptable operation. As some applications are more sensitive than others to network performance, the invention may also be implemented with applications run on the local devices of the members, or with a combination of networked and locally run applications. For example, the interface may be implemented as an application running on a server that controls execution of the associated applications on the server and displays the results on client devices. This second approach is particularly useful for handling remote participants who may have limited capabilities such as a web browser or a handheld device with limited display, application, and performance capabilities. In some installations some users might run the interface on their computer while others run it off the server.

It should be noted that it is not essential for every team member to have the collaboration tool. The interface may be utilized as a personal tool for a user with the responsibility to get a task or project accomplished. Although the members of the collaboration contribute by performing tasks, the interface may be employed primarily or solely by the coordinator to facilitate planning and execution of team actions. For example, if netmeeting is used for a meeting it may not matter whether the presentation is run by the presenter and shared with the team or if the coordinator runs it and passes control of the associated application to the remote presenter.

It should also be noted that synchronization of folders is not essential. In a particular project it might be that each team member has their own collaboration folder that is partially synchronized. The team may share a common calendar appointment and some files shared through email which is sufficient to prompt coordinated communication. Then, each member may launch their contribution from their own interface for sharing with the group. However it is also possible that a copy of the communication object is sent out with the calendar appointment in order to achieve some level of synchronization. A main advantage of having the collaboration tool is better personal organization and a central point for controlling all the communications applications, rather than synchronization.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of structures. Accordingly, the invention should not be viewed as limited except by the scope and spirit of the appended claims.

What is claimed is:

1. A computer interface that facilitates a collaboration between a plurality of users employing a plurality of distinct applications via a plurality of devices, comprising:
an information base containing information related to a task, said information base including information associated with a plurality of different applications and an accumulator for automatically adding new information related to the task to the information base; and
a communications manager for using and controlling different communications tools for communications with the users related to the task.

2. The interface of claim 1 wherein the information base includes a list of files associated with the collaboration, said files being available for use on the devices, and a calendar for scheduling events associated with the collaboration.

3. The interface of claim 1 wherein the communications manager includes a list of applications available for use in conjunction with the collaboration and a list of members of the collaboration.

4. The computer interface of claim 1 further including at least one native application which functions as part of the interface.

5. The computer interface of claim 3 further including a native application for creating and sharing hand drawings in real time.

6. The computer interface of claim 5 wherein said native application overlays said drawings on another file associated with another application.

7. The computer interface of claim 4 further including a native application for synchronizing internet browsing.

8. The computer interface of claim 1 wherein said information base includes at least one history file containing data associated with a completed collaboration session.

9. The computer interface of claim 8 wherein said at least one history file includes at least one audio file of a conference call.

10. The computer interface of claim 8 wherein said at least one history file includes at least one video file of a video conference.

11. The computer interface of claim 8 wherein said at least one history file includes at least one text file of an instant message sent pursuant to collaboration.

12. The computer interface of claim 8 wherein said at least one history file includes at least one file containing email messages sent pursuant to collaboration.

13. The computer interface of claim 8 wherein said history file includes at least one file containing a non-text file shared pursuant to collaboration.

14. The computer interface of claim 8 wherein said history file is automatically generated.

15. The computer interface of claim 1 wherein each said file is provided to said device associated with a member by dragging and dropping said file on an icon associated with said member.

16. The computer interface of claim 1 wherein a telephone call is initiated by dragging and dropping an icon associated with the member on a telephone icon.

17. The computer interface of claim 1 wherein the information base includes contact information, and wherein a contact may be added by selecting from a directory.

18. The computer interface of claim 17 wherein a subgroup of contacts is generated by selecting their associated icons and selecting an option to create a subgroup icon from a pull-down menu on the interface.

19. A communications object that facilitates collaboration between a plurality of users employing a plurality of distinct applications, comprising:
at least one file associated with at least one of said distinct applications, said file being provided to a plurality of devices in response to input; and
executable code operative to enable use of each said file in conjunction with its associated application by launching the application when the file is accessed.

20. The communications object of claim 19 wherein said at least one file includes a document associated with the collaboration.

21. The communications object of claim 19 wherein said at least one file includes at least one history file containing data associated with a completed collaboration session.

22. The communications object of claim 19 wherein said code includes at least one routine operative to interact with applications associated with the collaboration.

23. The communications object of claim 19 wherein said code includes at least one routine operative to reformat data from a first application format into a format readable by a second, different application.

24. The communications object of claim 19 wherein said code includes at least one routine operative to initiate a telephone call.

25. The communications object of claim 19 wherein said object is maintained on a server.

26. The communications object of claim 19 wherein said object is maintained as individual copies, one on each device.

27. A method for facilitating a collaboration between a plurality of users employing a plurality of distinct applications via a plurality of devices, comprising the steps of:
maintaining an information base containing information related to a task, said information base including information associated with a plurality of different applications;
automatically adding new information related to the task to the information base; and
providing a communications manager for using and controlling different communications tools for communications with the users related to the task.

28. The method of claim 27 wherein the information base includes a list of files associated with the collaboration, said files being available for use on the devices, and including the further step of providing a calendar for scheduling events associated with the collaboration.

29. The method of claim 27 including the further step of providing a list of applications available for use in conjunction with the collaboration and a list of members of the collaboration.

30. The method of claim 27 including the further step of executing a native application for creating and sharing hand drawings in real time.

31. The method of claim 27 including the further step of generating at least one history file containing data associated with a completed collaboration session.

32. The method of claim 31 wherein said history file is automatically generated.

33. The method of claim 31 wherein the information base includes contact information, and including the further step of adding a contact by selecting from a directory.

34. The method of claim 33 including the further step of generating a subgroup of contacts by selecting their associated icons and selecting an option to create a subgroup icon from a pull-down menu on the interface.
